(19) United States
(12) Patent Application Publication
(10) Pub. No.: US 2005/0147296 A1
(43) Pub. Date: Jul. 7, 2005

(54) Method of detecting counterfeit documents by profiling the printing process

(76) Inventors: David Hilton, Glos (GB); Weichao Tan, Oxford (GB)

Correspondence Address: Richard C Woodbridge;Synnestvedt Lechner & Woodbridge, PO Box 592, Princeton, NJ, 08542-0592, US

(21) Appl. No.: 10/510,374

(22) PCT Filed: Apr. 15, 2003
(86) PCT No.: PCT/GB03/01614

(30) Foreign Application Priority Data
Apr. 15, 2002 (GB) 0208599.1

(51) Int. Cl. G06K 9/00

(52) U.S. Cl. 382/170; 382/135; 382/137

(57) ABSTRACT

This invention is concerned with the automatic detection of counterfeit documents, particularly checks and currency, through the analysis of images. The method relies on the production of profiles which represent the characteristics of authentic documents and their comparison with similarly extracted profiles from putative authentic documents. In one implementation involving the mass processing of checks the authentic profiles are continuously updated by analysis of large numbers of contemporarily processed checks.

### FIELD OF THE INVENTION

This invention relates to a method of detecting counterfeit documents, particularly printed documents such as checks and currency.

### BACKGROUND TO THE INVENTION

Counterfeiting of currency and valuable documents is an activity which has attracted fraudsters throughout the ages and shows no signs of abating. Measures to protect currency are numerous and diverse. They include the use of highly specialised materials to construct documents and inclusion within the document of a number of devices which are considered difficult to reproduce accurately. Thus the quality of paper is a matter for careful consideration, likewise the properties of the inks used for printing. More elaborate devices such as holograms and metallic strips are included amongst these measures.

Protection is also provided by the printing of elaborate patterns that are difficult to reproduce without making apparent certain concealed designs. These are typically based on the moire phenomenon and the use of lines that are almost parallel, as for instance described in the patent U.S. Pat. No. 05193853.

The improvement in quality of cheap scanners and inkjet printers has conferred the ability to reproduce currency with a higher level of fidelity to the original and has to a degree undermined the protection offered by techniques that depend solely on printed patterns. Visually, some of this counterfeited material can be quite acceptable and could easily be passed off as genuine in ill lit environments, or in any context where there is little time or inclination to check for authenticity.

There is, for instance, a form of attempted protection where the detailed line structure is such that a recognisable feature becomes visible after reproduction at a fairly low resolution. U.S. Pat. No. 05951055, for instance, describes the embedding of an image with a different screening from the background which generally becomes visible on reproduction by photocopiers. However, the currently achievable quality of reproduction with readily available scanners and printers is sometimes sufficient to defeat these kinds of embedded patterns in the sense that no warning pattern becomes visible. This type of counterfeiting deterrence also has the disadvantage that it requires individual inspection of notes and is not easily amenable to machine detection.

A more recent development has been in the field of digital watermarking, where a signal is added at a barely perceptible level but can be detected by scanning and carrying out a statistical accumulation of data. This method generally involves the embedding of an amount of digital data. The watermark may be used in two ways. First, the presence of the watermark may be taken as an indication that the document has not been degraded and hence is probably an original. The second usage is to prevent the production of copies by inserting in photocopiers and scanners means to discern watermarks of the type that might be embedded in currency and, following the discernment, to disable the copying process. European patent application EP00961239A2 addresses this type of protection.

A weakness of the watermarking method is that in most cases watermarks require the geometric attributes of the image to be largely preserved. Attacks on watermarks often feature minor distortions in order to benefit from this weakness. This is true even of watermarks generated using wavelets or in the frequency domain. This means that documents that are damaged by tearing or crumpling will tend to lose their watermarks. A further weakness of most forms of watermarking is that the method is not sufficiently robust to withstand the degradation of images brought about in bulk processing where typically high speed scanners operate at low resolution and generate artefacts as a result of movement of paper etc.

In U.S. Pat. No. 05553162, Gaborski describes a method of profiling print output but his concern is to distinguish between dot matrix and ink jet printers and not between outputs from different models of the same printer.

### SUMMARY OF THE INVENTION

This invention concerns the detection of counterfeit documents using only the properties of standard printing procedures and without the use of specialist inks, metallic strips or other physical devices.

The essential feature of the invention is the measuring of characteristic profiles of output by printers or photocopiers onto any substrate. Knowledge of the profile of the authorised production devices allows a comparison to be made with the profile of any document that purports to be authentic. Thus the detection of counterfeits is based on the recognition of characteristics of possible means of reproduction on the basis that no two means of reproduction produce identical profiles if the method of profiling is carefully selected. The invention is concerned with the detection of copies of documents and not with the integrity of data within those documents. The actions to be taken upon the discovery of a counterfeit are not the subject of this invention.

There is in general no need to print any extra pattern onto the document; there is usually on a security document sufficient art work or printing of fine lines to enable a representative profile to be calculated. There may be an improved performance if a feature is added with sufficient detail to give a wide range of configurations of black and white pixels and hence a more detailed profile.

In one implementation the invention is used to protect currency. In this case, the profiles are typically calculated using the elaborate sort of pattern which is generally part of a currency design. There is generally enough uniformity in the production process to allow calculation of the profile at the time of production of the currency and this profile can be circulated to those remote points where detection will take place.

In a second implementation, which is mainly concerned with the protection of checks, variable data such as payee, account number etc. is printed just prior to issuance. This printed data can replace the line patterns above as the vehicle through which unauthorised duplication can be detected. In some applications, machine readable code is printed at the same time as human readable data and if the nature of this is correctly chosen it can be the means of calculating the print profile. The structure of such machine readable data can be selected so as to increase the detail in any profile

The main context for this implementation is where large numbers of checks are printed with their individual data just prior to issuance and where checks are scanned in large numbers. This results in a situation where a characteristic profile of a valid check can be calculated, and comparison with this profile enables fraudulent checks to be identified.

In this implementation, there is no original electronic file to serve as a standard but instead a host of exemplars of authentic checks from which to take measurements. The scheme thus maintains an ongoing calibration, meaning that any fraudster would need to know the current state of printers in order to be able to produce an acceptable counterfeit.

The profiles that are produced in any of the implementations typically depend upon the accumulation of very localised parameters. The present invention may therefore rely on the measurement of “intensive” variables: variables that are not primarily dependent on the extent or shape of an image. This contrasts with “extensive” variables, which depend on the extent or shape of an image and would thus be corrupted by stretching or the like. This has the advantage that the profiles are robust under quite extreme forms of degradation such as crumpling, and in this it contrasts with most forms of watermarking.

### BRIEF DESCRIPTION OF THE DRAWINGS

The present invention will be described with reference to the accompanying drawings, in which:

FIG. 1a is a histogram showing the distribution of a print diffusion profile for a tartan pattern;

FIG. 1b is a histogram showing the first derivative of the FIG. 1a distribution of a print diffusion profile for a tartan pattern;

FIG. 2a is a histogram showing the distribution of a print diffusion profile for a pyramid pattern;

FIG. 2b is a histogram showing the first derivative of the FIG. 2a distribution of a print diffusion profile for a pyramid pattern;

FIG. 3a is a neighbouring profile analysis;

FIG. 3b is a matrix for a neighbouring profile index;

FIG. 3c shows the neighbouring profiles that correspond to the main peaks in FIG. 3a.

FIG. 3d is a alternative matrix for a neighbouring profile index;

FIG. 4a is a glyph pattern;

FIG. 4b is a histogram of glyph quality.

### DETAILED DESCRIPTION

The invention is concerned with the identification of counterfeit documents, particularly checks and currency. The authentic documents are produced by the existing methods or with a small modification and their characteristics precisely calculated. When it is required to test a supposedly authentic document, the characteristics of the particular document are again calculated, by analysis of a scanned image and profiled; the profile is then compared with the profile of the characteristics of an authentic document. Thus a judgement of authenticity can be made.

The overall implementation of the invention thus involves three fundamental processes. The first is the specification of the characteristics whose profile is to be measured and an algorithm for producing the profile. The second is the establishment of the expected profiles for authentic documents. The third is the scanning and analysis of the suspected documents as a means of comparing with acceptable profiles.

The production of profiles (or, equivalently, indices) of the characteristics requires the selection of some or all of the printed output on security documents as a vehicle for profile calculation. The printed output may be part of an existing design on a security document or it may be an extra design for the production of profiles. An important feature is that if an extra design is required it is implemented using the same printing process that is already used in the document production. In particular there are no holograms, metal strips or inks with special spectral properties that need be involved.

As a result of these considerations, implementation of the invention is generally cheap, requiring little or no additional materials at the print stage, and even where additional designs need to be applied there should be minimal interruption of the workflow in what is typically a high speed printing environment.

Design of Profiles

The design of profiles/indices depends upon the nature of the document being protected. There are many possibilities for calculation of indices for profiles: four are exemplified below but do not in any way exclude other possibilities.

(1) Indices for Line Art Security Patterns

One implementation is concerned with protection of currency, but is equally applicable to any security documents which make use of line patterns. Passports, IDs, driving licences etc. fall within this category.

There are certain standard patterns which currency printers tend to generate for their designs because they provide a suitable background matrix and, by their fine structure, are difficult to copy. This implementation requires that such a line pattern be present in the currency under consideration. Preferably the lines will be at a frequency of at least 50 per inch and there must be clear space between the lines. Such lines are present, for instance, on a UK ten pound note. One method according to this invention for producing profiles/indices measures the diffusion effect of printing and scanning on line edges. Scanned data values will include many transitions from high values to low values in whatever colour space or luminance space is being used, corresponding to the change of visual effect between the peak of the lines and the intervening valleys. A differencing filter can be applied to collect data describing the jump from any pixel to its neighbour.

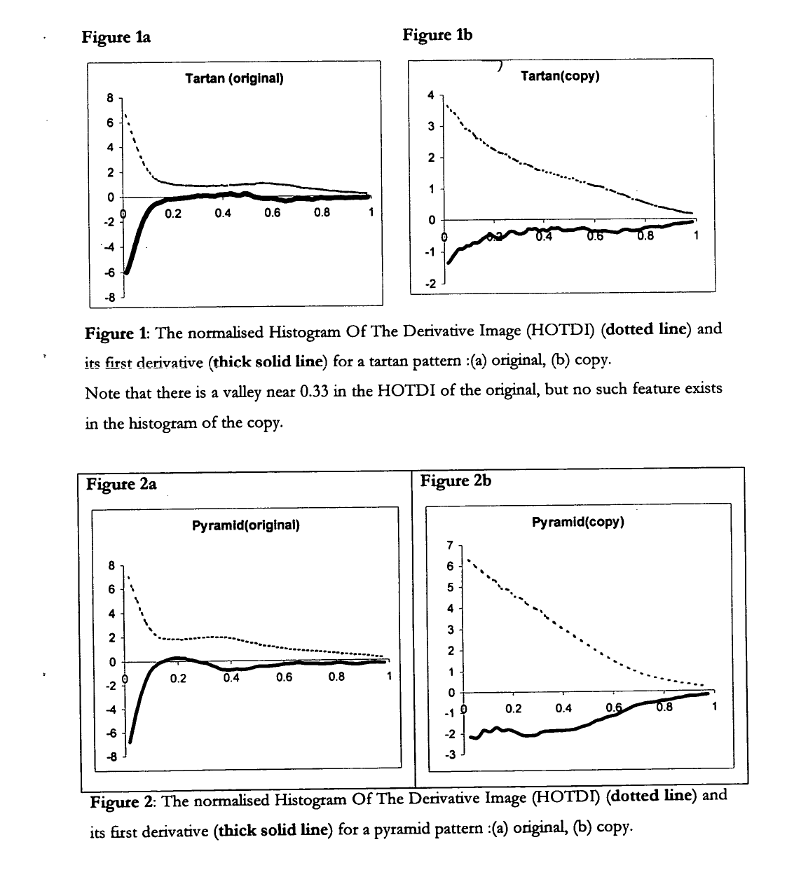

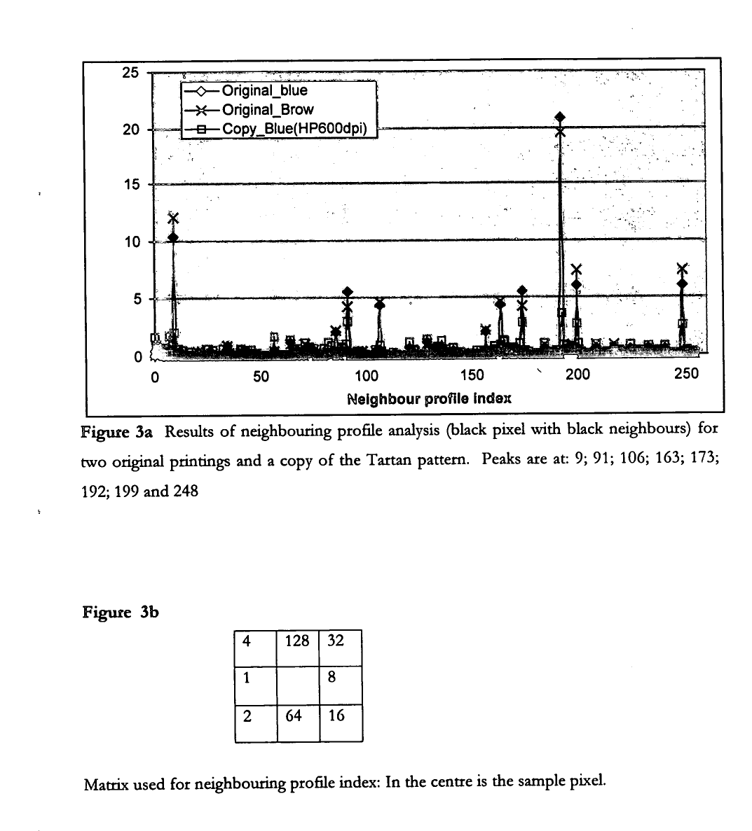

From this derivative image, a histogram can be created. FIGS. 1a and 2a, illustrate a typical histogram for each of two common line patterns (tartan and pyramid, respectively).

The histograms of FIGS. 1 and 2 have the same axes. The x axis was originally found by taking the absolute value of the difference between neighbouring pixels, thus ranging from 0 to 255. This range was then scaled down from 0 to 1.0. The y axis was originally the frequency of the difference value but was scaled down to make the area under the curve equal to unity, thus facilitating comparison with histograms taken from different sized samples of images.

The histograms have a peak and a valley arising from the fact that there are certain characteristic jumps which occur when lines are printed at high quality in a single colour. These features and the general shape of the curve can be expressed in mathematical terms. One simple expression is illustrated by the derivative curve which has zeros.

This histogram of the original is to be compared with that obtained after attempts to copy the currency using a scanner and an inkjet printer. A typical histogram of this type is illustrated in FIGS. 1b and 2b. The peaks and valleys have been eliminated and there are no zeros in the derivative curve.

The reason for the change of histogram is that the inkjet printer will typically add a further diffuseness to the line pattern, thus producing derivative values in a more or less continuous distribution. The histogram will therefore have no peaks or valleys corresponding to preferred or unlikely values.

One reason for diffuseness on ink jet printers is the fact that they generally print in three or more colours and will attempt to simulate the spot colour on the currency by the use of three or more dots of different colours. The derivative image produced from the scan will correspond to changes in luminance, which will in turn be composed of contributions from several colours resulting in a general spread of values.

The histograms will vary according to all of the parameters involved in the printing and scanning process. These parameters include paper quality, print resolution, colour chosen for the pattern, frequency of the line pattern and so on. It is nonetheless possible to produce characteristic values for the histograms that will allow a threshold between originals and copies to be identified for a wide range of contexts, thereby providing sensitive indices to describe the printing characteristics.

(ii) Indices of Edge Deformation

A second profiling method, according to this invention for detecting counterfeits, measures the fragmentation and edge deformation arising from the copying process.

If a straight line in an electronic file is printed, the straight edge will undergo a degree of deformation, more especially if the substrate is fibrous paper where the ink flow cannot be precisely predicted. If this printed version, which could be, for example, a cheque or an item of currency, is scanned, the scanner cannot be precisely aligned with the pixels of the original pattern. Thus, in addition to the inevitable noise introduced by the scanning hardware there is a kiiad of sampling error. This is more apparent if the scan is in black and white rather than contone or if the scan, originally in contone, is thresholded. The main result of this is that after lines have been copied and scanned to a black and white image the lines will be more fragmented and irregular. The objective in this invention is to provide metrics that will reflect the degree of fragmentation.

One metric is obtained by considering for each black pixel the number of black neighbours. Thus points on the edge of a straight line would have 5 black neighbours, as illustrated by the pixel marked ‘P’ below.
WWWWWWWWWWWWW
BBBBBBBBPBBBBBBBBB
BBBBBBBBBBBBBBBBBB
BBBBBBBBBBBBBBBBBB
WWWWWWWWWWWWW

After copying the line might become more irregular as illustrated below. In this case P has only 4 black neighbours.
WWWBWWWWBWWWW
BBBBBBWWPBBWBBBBBB
BBBBBBBBBBBBBBBBBB
BBBBBBBBBBBBBBBBBB
WWWWWWWWWWWWW

Thus a simple method of describing the fragmentation would be by a histogram of the numbers of neighbours for each point. In relatively low grade copying this is sufficient to distinguish a copy from and original.

(iii) General Configuration Indices

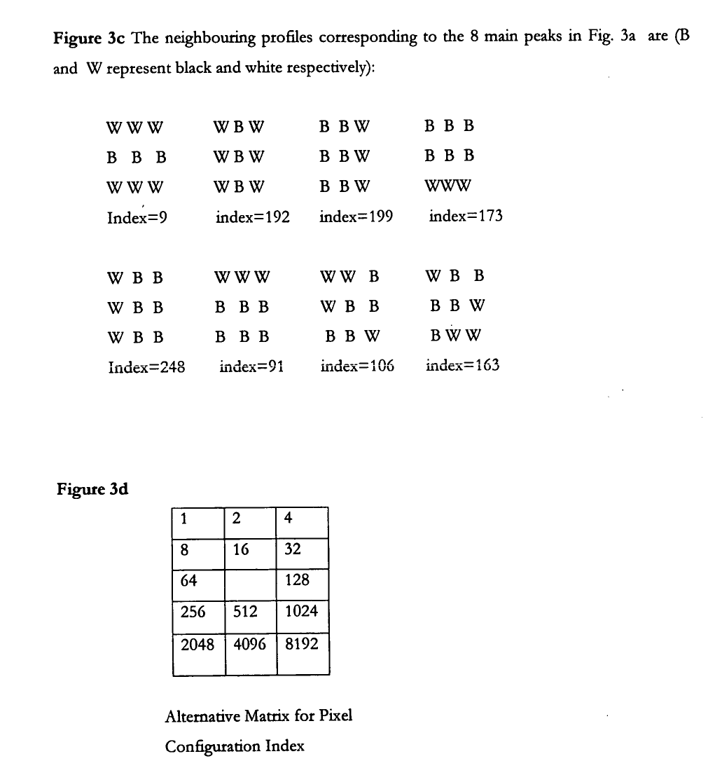

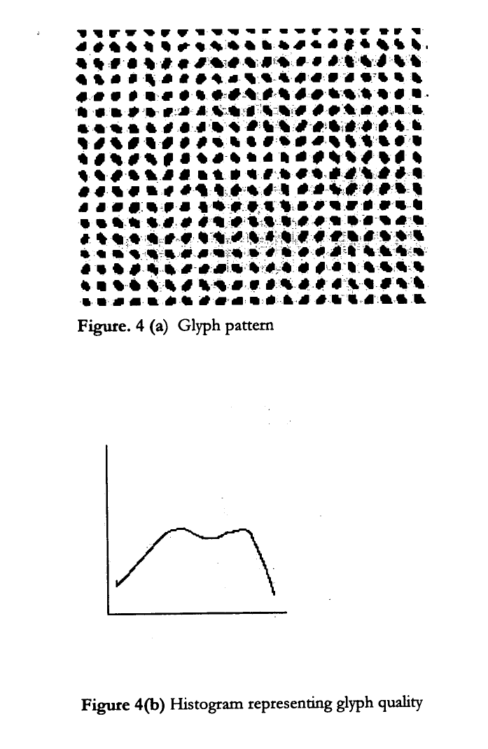

To develop the invention further, a means of classifying pixels is devised as in FIG. 3b. Each of the surrounding pixels is given an arbitrary value so that the sum of the values gives a unique description of the configuration: FIG. 3c shows some of the different potential combinations of black and white pixel configurations that might be detected in a scan and the related values obtained using the matrix of values (a value is attributed only where a black pixel is actually detected at a position). This allows one to map the different kinds of distortions to a block of 3×3 black pixels that are introduced by specific printers and scanners. FIG. 3a shows the result of analysing an image using this metric. The profile obtained compared with that of a copy of the same document will show a clear distinction. FIG. 3(a) shows the profiles for two original examples of the tartan pattern, one printed in blue ink and the other in brown. The figure shows that even with different colours, the profiles of the originals are similar. The figure also shows the profile of a copy and this differs considerably, particularly in that its peaks are lower and more widely spread (although that is not easy to see in the given diagram.)

This method of producing indices can be purely empirical in that the indices are not theoretically predicted by consideration of the deterioration in quality of copies but rather rely on the fact that printers and scanners (flatbed, web cameras, digital cameras etc.) impart their own fingerprint onto copies. The indices essentially measure and compare these fingerprints to sort out counterfeits.

Some degree of geometric interpretation can be deduced from some indices. For instance, certain configurations can be classified as ‘good,’ i.e. more common in smooth originals, and certain configurations as ‘bad’ and an index can be formed from the ratio of the two.

The 3×3 group of pixels used for the index computation can be changed to reflect particular types of document. Thus 4×4 matrices might be used, or elongated shapes if, for instance, the document in question contained extended horizontal features. FIG. 3(d) illustrates a possible numbering system for a 3×5 matrix. There are in fact hundreds of possible configurations which could give rise to informational indices.

This method of profiling is particularly well suited to the testing of checks, using the printing of variable data as the vehicle for profile calculation. However, the amount of text printed may be limited to such as the payee name and amount, and it is better if a more varied design is included to provide a larger sampling area. In some cases checks are printed with information bearing seals or logos and these may be the ideal vehicles for profile generation if they are constructed so as to include a wide range of configurations of pixels.

In another implementation, the method of calculating indices is extended from black and white images to greyscale images by choosing thresholds to convert the greyscale to black and white and calculating the indices as previously. A range of indices can be generated using several different thresholds, the levels of the thresholds generally being selected with reference to the mean and standard deviation of the grey level.

It is also possible to embed information about the profiles into the document in an encoded form to make detection of copies self-contained.

(iv) Indices Derived from Constructed Features

If a feature is constructed by repetition of a particular feature (as with sets of glyphs, for example) a valuable set of indices can be generated. Considering conventional glyphs whose symbols are short line segments at 45 degrees to the forward or backward horizontal, the quality of the output can be measured by the extent to which the scanned glyphs are accurate reproductions of the original. Thus if a glyph appears as a clear forward diagonal it can be allocated the value +100 whereas if it appears as a clear backward diagoanl it can be allocated the value −100. A glyph which is a blurred version of the forward diagonal might be allocated the value +40. By analysing all of the glyphs in this manner a distribution will be established. This distribution will be clearly bimodal if the scanned image is sharp whereas it will be tend to have a central peak if the image is degraded. The same method may be applied to features made up of horizontal and vertical lines.

The indices derived as described above will only be mildly affected by degradation of the scanned images resulting from crumpling of the document because the characteristics measured are very localised and do not concern the geometrical relationship between remote pixels.

Production of Standard Profiles

Having established a system for creating profiles of characteristics of documents, the requirement is for a means of producing standard profiles which will act as a benchmark for suspect counterfeit documents.

There are two distinct implementations for the production of standardised profiles. The first, suitable for protection of currency, relies on the fact that there are tight quality controls on the printing of currency and it is therefore possible to produce at the time of printing a profile which reasonably represents the characteristics of authentic documents. The second is for cases such as checks where variable data is added at the time of issuance and where there is rather greater divergence of quality between different print runs. In this case the implementation assumes there are sufficient numbers of authentic checks available to establish a range of acceptable profiles.

Taking the first of these implementations, the vehicle for profiling is usually a line art pattern on some denomination of currency. The environment for currency production is tightly defined. The substrate and inks are precisely specified and the range within which printers vary is accurately known.

Occasional samples from a print run can be taken and scanned and profiles calculated and distributed to those points where currency is to be tested. Because of the printing accuracy, occasional samples are enough to generate data for statistically valid profiles. The problem however is that calculation of the profile depends not only on the print output but also on the quality and resolution of the scanner. One method of dealing with this is to calibrate scanners. Conversion algorithms can be designed which convert a given scanner output to a standard form dependent on the resolution of the scanner and preferably on the results of scanning a calibration sheet.

The second method for standardising profiles requires an ongoing regular, continuous process to generate statistically valid profiles. It is suitable for automatic check processing on a large scale. In this case the image segment used for the profiles is likely to be text data or some logo data printed by a laser printer at the time of issuance. The profile used is likely to be the set of indices derived from the configurations of black pixels appearing on the scanned image.

The output of high speed printers varies from one printer to another, but more than that, there is a variation with time as, for instance, the amount of toner changes. In a typical scenario thousands of checks will be scanned daily on high speed scanners. The data on the checks will indicate which printer has been used for printing each of the checks and what was the sequence of printing. A set of images is taken from a scanner where there may be large numbers of images corresponding to checks produced on a particular printer during a particular period of time. This will provide the maximum probability of there being a set of authentic checks with closely matching characteristics where a counterfeit would stand out.

In one implementation, a set of indices is calculated from each scanned image, where the indices may include values representing various configurations or more general indices such as ratio of black to white pixels in a given area.

In a typical context a set of many indices may have been defined but not all indices are significant and so a process of refining the set takes place. Suppose there is a set of indices I(s,i) where “s” is the sample number of the check image and “i” is the reference number of the index. There could be, for example 5,000 checks and 200 indices, i.e. “s” runs from 1 to 5,000 and “i” runs from 1 to 200.

Inspection of the indices will normally show that some are not significant in the sense that their fluctuation is large compared with their mean values, or, if they simply count occurrences of particular configurations, there are many cases where the count will be zero or very small. These indices may be discarded.

Mean values of the remaining indices will be calculated for the set of checks. Those checks whose indices differ abnormally from these mean values will be disregarded as far as the initial calibration process goes.

It will also be the case that some of the indices are mutually dependent and hence add no real information. These can be sorted out by calculating the correlation between pairs of the indices. A threshold may be chosen such that if the correlation between a pair of indices exceeds the threshold one of the pair of indices will be discarded. A threshold of roughly 0.95 is not uncommon.

By these means the number of indices is reduced to perhaps 60. These 60 indices are then calculated for all of the checks in the selected set and the mean values of the indices calculated.

The identification of exceptional checks is then carried out by consideration of the total “distance” from the mean of the indices corresponding to a given check. The “distance” is an algebraic entity that needs to be defined in terms of a metric that takes into account the correlation between variables and their range of variation.

One possible metric is the “Mahalonobis distance.” This adjusts the distance between two sets of indices by considering the mutual covariance between pairs of indices. The relevant distance is given the formula:

Distance=I C⁻¹ I^{T} where I is the vector of indices and C the matrix of covariances of the indices.

The process is now to take all of the scanned images and calculate their indices and their “Mahalonobis distances” from the overall mean. On the assumption that by far the majority of checks are authentic, a distribution for these distances can be found. The range of the distribution depends on the degree to which the environment for the group of checks has been maintained. Thus if all of the checks in a particular sample were to be printed by the same printer and scanned on the same scanner and the scanner were to be continually monitored for deposits of toner on the lens etc. then the Mahalonobis distances would lie within a tightly defined range. In this circumstance a counterfeit document would be identifiable as being clearly outside the range. It should be borne in mind that to be within range means that a document must have similar characteristics to an authentic document over a large number of indices, the indices providing a very accurate description of the printing attributes.

1. A method of detecting unauthorised copies of a genuine document, comprising the steps of:
(a) computing profiles of a printing characteristic derivable from a set of documents that are known or can be assumed to be largely genuine, the characteristic being associated with the output of a printer that prints genuine documents and not being intrinsic to the original document;
(b) analysing the profiles to assess the probability that any given document within the set, or additional to it, is in fact genuine.

2. The method of claim 1 in which the characteristic is the degree of print diffusion on line edges.

3. The method of claim 1 in which the characteristic is the degree of line fragmentation.

4. The method of claim 1 in which the characteristic is the degree of edge deformation.

5. The method of claim 1 in which the characteristic is the configuration of pixels.

6. The method of claim 1 in which the characteristic is the orientation of glyphs.

7. The method of claim 1 in which the profile is represented in a histogram.

8. The method of claim 7 in which the profile is represented as a first derivative of the histogram.

9. The method of claim 1 in which profile related data is written into the document.

10. The method of claim 1 in which the profile is generated and updated as a consequence of large numbers of printed documents being regularly analysed.

11. The method of claim 10 in which the document is a cheque.

12. The method of claim 1 in which the original is accurately printed in a controlled environment and the profile is generated using occasional samples.

13. The method of claim 12 in which the document is currency, a driving license, ID, or a passport.

14. The method of claim 1 in which the original is modified by including a special printed feature designed to facilitate profile comparison.

15. The method of claim 1 comprising the steps of generating a mean value for several profiles and determining the distance from this mean of each of a large number of sample documents, so that any counterfeit documents in the sample fall outside of the distance distribution associated with authentic documents.
